(19) United States
(12) Patent Application Publication
(10) Pub. No.: US 2011/0253077 A1
(43) Pub. Date: Oct. 20, 2011

(54) Reversible Double-Acting Electromagnetic Device For Transmitting The Movement To/From A Driven/Driving Member

(75) Inventors: Piercarlo Boffelli, Milano (IT); Fabio Natale, San Giuliano Milanese (IT); Erminio Depoli, Crema (IT); Claudio Bellotti, Cerro Al Lambro (IT)

(73) Assignee: Baruffaldi S.p.a., Tribiano (IT)

(21) Appl. No.: 13/086,689

(22) Filed: Apr. 14, 2011

(30) Foreign Application Priority Data
Apr. 15, 2010 (IT) MI2010A000644

(51) Int. Cl. F16D 27/12; F16D 47/00; F01P 5/10; F16D 27/04

(52) U.S. Cl. 123/41.44; 192/48.2

(57) ABSTRACT

A double-acting electromagnetic device for transmitting movement to/from a driven/driving member in a vehicle and including a shaft that rotates about a longitudinal axis of rotation and that has, mounted relative thereto a first rotor of a first coupling including a pair of concentric annular electromagnets mounted on a fixed support, a coaxial bell member, a coaxial cup member, a first bearing, a first armature connected to the coaxial bell member, a second armature concentric with the first armature and connected to the coaxial cup member which is mounted idle with respect to the shaft via the first bearing and which has a first pulley formed on a side surface, wherein the support for the electromagnets is attached to a fixed structure part which has a load-bearing function, and wherein the bell member includes an outer annular edge extending in an axial direction towards the electromagnets and mounted axially over the first rotor.

### CROSS-REFERENCE TO RELATED ACTIONS

This application claims the benefit of and priority to Italian Patent Application No. MI2010A 000644, filed Apr. 15, 2010, which is incorporated by reference herein in its entirety.

### BACKGROUND

It is known in the technical sector relating to the cooling of coolants contained in the radiators of motor-vehicles that there exists the need to force air onto the radiator itself so as to be able to obtain more rapid dissipation of heat from the liquid to the outside, said flow of forced air being obtained by causing the rotation of a fan, which is normally mounted on the shaft of the water pump or on the driving shaft or on a driven and fixed shaft carrying a pulley which receives the movement from a belt actuated by the driving shaft.

It is also known that said fan must be made to rotate only when a certain predefined temperature of the water has been reached, said temperature being detected by means of a thermostat which activates an electromagnetic clutch, closing of which causes the fan to start rotating.

Typically a motor-vehicle fan may rotate i) at a speed slower than that of the drive shaft for cooling in conditions where there is a low external temperature, ii) at a speed which is the same as or even greater than that of the drive shaft when there are high external temperatures or during use under extreme conditions which cause overheating of the engine, and iii) at zero speed, namely with the fan which does not rotate at all and remains in the idle condition relative to the drive shaft, in the case of particularly low temperatures where further cooling is unnecessary or even harmful.

In attempt to obtain such behavioral features, two-speed couplings with electromagnetically controlled friction clutches have been developed. Although performing their function these known couplings nevertheless have a number of drawbacks arising in particular from the fact that the radial stresses arising from the drive belt are transmitted to the rotating parts which are therefore subject to vibrations and wear which reduce the working life and transmit said stresses to the driven shafts of the apparatus which are connected, resulting in the need to design the bearings supporting said shafts with larger dimensions. In addition, the known solutions have large axial dimensions which pose a problem for all those applications where the dimensions of the engine are such that there is not sufficient axial space available.

### SUMMARY

In general, in an aspect, embodiments of the invention can provide a double-acting electromagnetic device for transmitting movement to/from a driven/driving member in a vehicle and including a shaft that rotates about a longitudinal axis of rotation and that has, mounted relative thereto a first rotor of a first coupling including a pair of concentric annular electromagnets mounted on a fixed support, a coaxial bell member, a coaxial cup member, a first bearing, a first armature connected to the coaxial bell member, a second armature concentric with the first armature and connected to the coaxial cup member which is mounted idle with respect to the shaft via the first bearing and which has a first pulley formed on a side surface, wherein the support for the electromagnets is attached to a fixed structure part which has a load-bearing function, and wherein the bell member includes an outer annular edge extending in an axial direction towards the electromagnets and mounted axially over the first rotor.

Implementations of the invention can provide one or more of the following features. The device according to claim 1, wherein a second pulley with grooves, suitable for engagement with a first drive belt, is formed on an outer radial surface of the outer annular edge of the bell member. The second armature is integral with a first front end of a coaxial cylindrical body, the other end of which carries the coaxial cup member. A coaxial cylindrical body is mounted on an outer ring of the first bearing keyed onto the shaft. The first armature and second armature are respectively connected to the bell member and the cup member by an associated resilient element that is configured to allow axial movements of the armature, but prevent the relative rotation thereof with respect to its support. The first armature and second armature are axially disposed between the first rotor and a bottom of the bell member. The cup member is axially disposed over the cylindrical body. The operation of the shaft is reversible so that said shaft is operable as a driven shaft and a driving shaft.

Implementations of the invention can also provide one or more of the following features. The shaft is axially extended on the side opposite to the first rotor, with respect to the electromagnets of the first coupling, forming a journal on which a second coupling is mounted. The second coupling includes a third pulley, which is mounted on a second bearing keyed onto the journal and to a front surface of which a third armature is connected by an associated resilient element, a second rotor which is rotationally integral with the journal and axially opposite to the third armature, and a third electromagnet which is disposed on the side opposite to the third armature, with respect to the second rotor, and which is mounted on the same support that carries the electromagnets.

Implementations of the invention can also provide one or more of the following features. The journal is integral with the shaft. The journal is independent of the shaft. The third pulley of the second coupling rotates in the opposite direction to the direction of rotation of the second pulley and the first pulley of the first coupling. At least one of the electromagnets of the first coupling is associated with a permanent magnet able to keep the respective armature attracted against the first rotor and to be neutralized by excitation of the said electromagnet. The first electromagnet is seated inside an associated support that is attached to the support of the second electromagnet with a layer of insulating material disposed in between. The device further includes means for cooling the coolant that comprises at least one of a fan and a fluid recirculation pump.

Various aspects of the invention may provide one or more of the following capabilities. A fan can rotate at a number of revolutions different from that of the driving shaft and able to be determined depending on the actual need for cooling said coolant. A device for rotating a fan can have compact axial dimensions, with radial stresses that are not transmitted to the rotating parts. The fan should be able to be stopped in the idle position. These and other capabilities of the invention, along with the invention itself, will be more fully understood after a review of the following figures, detailed description, and claims.

### BRIEF DESCRIPTION OF THE FIGURES

FIG. 1 shows a schematic axially sectioned view of a first embodiment of the device for transmitting the movement to the fan according to the present invention in the idle condition.

FIG. 2 shows a schematic axially sectioned view of a second embodiment of the device according to the present invention.

FIG. 3 shows a schematic axially sectioned view of a third embodiment of the device according to the present invention.

FIG. 4 shows a schematic axially sectioned view of a fourth embodiment of the device according to the present invention.

### DETAILED DESCRIPTION

Embodiments of present invention relate to a reversible double-acting electromagnetic coupling for transmitting the movement to/from a driven/driving member in particular for devices for cooling the coolant in vehicles. One technical problem which is posed is to provide a device for transmitting the rotational movement to a fan for cooling the coolant in motor vehicles, which is able to allow the fan to rotate at a number of revolutions different from that of the driving shaft and able to be determined depending on the actual need for cooling said coolant, which device has compact axial dimensions, with radial stresses which are not transmitted to the rotating parts. In connection with this problem the device should also be able to keep the fan stopped in the idle position and also ensure safe rotation of the fan also in the case of a malfunction affecting the associated power supply and control devices. These technical problems can be solved using embodiments of the present invention that preferably include a reversible electromagnetically controlled friction coupling for transmitting the movement from/to a driven/driving member in particular for a fan for cooling the coolant in a motor vehicle.

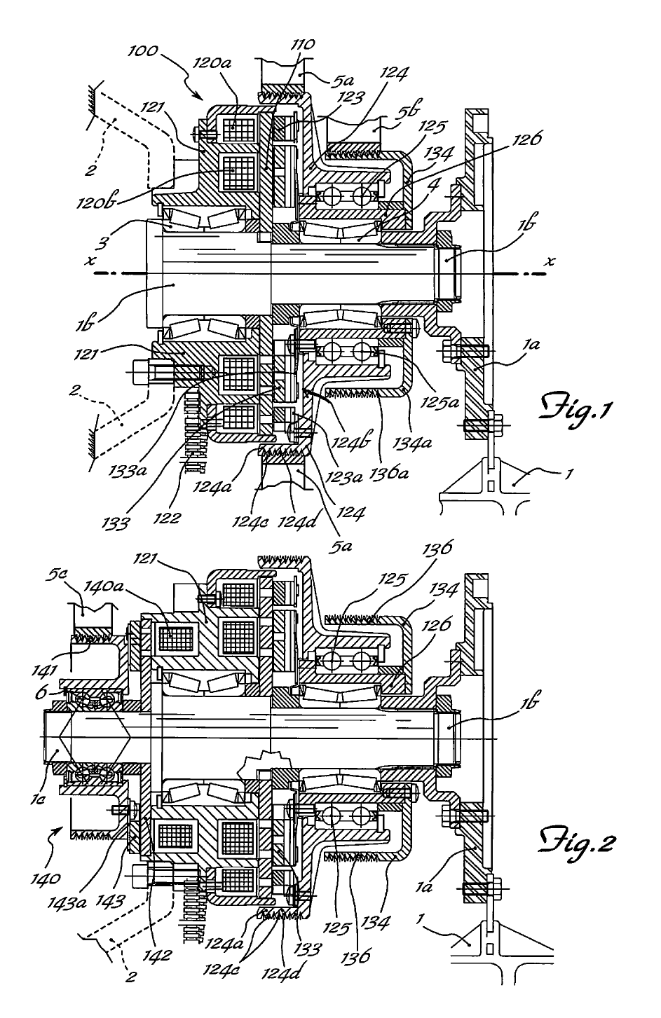

As shown in FIG. 1 a cooling fan 1 is attached to a support flange 1a arranged on a coaxial shaft 1b. For the sake of convenience below, longitudinal direction X-X will be understood as that direction coinciding/parallel with the axis of rotation of the shaft 1b. The same shaft 1b also preferably has, mounted thereon, a rotor 110 which forms the rotating member of a first coupling 100 comprising a pair of annular electromagnets 120a,120b which are preferably concentric and mounted on a fixed support 121 which is in turn attached to a fixed structure 2 for example formed by the base of the vehicle engine. The fixed support 121 is preferably mounted idle on the outer ring of a bearing 3 mounted on the rotating shaft 1b. The electromagnets 120a,120b are preferably electrically connected by means of wires 122 to a thermostat (not shown) for, for example, controlling the temperature of the coolant.

A first armature 123 is preferably arranged on the opposite side to the electromagnets 120a,120b, with respect to the rotor 110, said armature being connected to an annular bell member 124 which is preferably integral with the outer ring 125a of a first bearing 125 which is in turn mounted on a cylindrical body 126 mounted on the outer ring of a second bearing 4 keyed onto the shaft 1b. According to a preferred embodiment, the bell member 124 preferably has an outer annular edge 124a extending in an axial direction towards the electromagnets 120a, 120b so as to be mounted axially over the rotor 110. A space able to contain the said first armature 123 of the coupling is preferably formed axially between the rotor 110 and the bottom 124b of the bell member.

A pulley 124c with grooves 124d suitable for engagement with a first drive belt 5a can be formed on the outer surface of the annular edge 124a. The connection between armature 123 and bell member 124 is preferably obtained by means of the arrangement, in between, of a resilient element 123a designed to allow axial movements of the armature 123, but prevent relative rotation of the armature and the bell 124. A cup member 134 is preferably axially connected to the end axially directed towards the fan side of the cylindrical body 126 and preferably has, formed on its annular surface 134a, a second pulley 136 with grooves 136a suitable for engagement with a second drive belt 5b. The opposite end of the cylindrical body 126 is, in turn, preferably axially connected to a second armature 133 by means of an associated resilient element 133a which is designed to allow axial movements of the armature 133, but prevent the relative rotation of armature and cylindrical body 126. The second armature 133 also preferably lies axially between the rotor 110 and the bottom 124b of the bell member 124, being concentric with the first armature 123.

The cup member 134 is preferably axially arranged over the cylindrical body 126, thus helping reduce the axial dimensions of the assembly. With this configuration the operating principle of the coupling can be as follows:
Driven shaft 1b
   The first pulley 5a and the second pulley 5b are configured for transmitting the movement rotationally to actuate the respective bell member 124 and cup member 134;
   The excitation of only the first electromagnet 120a preferably attracts the first armature 123 against the rotor 121, causing rotation of the shaft 1b and therefore the fan 1 at a speed slower than the operating speed;
   the excitation of only the second electromagnet 120b preferably attracts the second armature 133 against the rotor 110, causing rotation of the shaft 1b and therefore the fan 1 at a speed the same as the operating speed;
   when both the electromagnets are de-energized, the shaft 1b and therefore the fan 1 preferably remain stationary in the idle condition.
Driving shaft 1b
   In this case it is assumed that the actuating movement is imparted via means (not shown) to the shaft 1b which becomes a driving element like the rotor 110
   Then excitation of either one of the two electromagnets 120a,120b will preferably alternately cause rotation of the bell member 124 or the cup member 134 via the respective armatures 123, 133, causing transmission of the movement in a radial direction to the belts 5a,5b.

FIG. 2 shows a further embodiment of the coupling according to the invention in which it is envisaged that the shaft 1b is axially extended on the opposite side to the fan 1, forming a journal 1c on which a second coupling 140 is mounted, said second coupling preferably including:
A bearing 6 keyed onto the journal 1c supporting a pulley 141, the front surface of which is preferably connected to an armature 143 via an associated resilient element 143a which is designed to allow axial movements of the armature 143, but prevent relative rotation with respect to the pulley 141;
A rotor 142, rotationally integral with the journal 1c and, axially opposite to the armature 143,
A third electromagnet 140a which is arranged on the opposite side to the armature 143, with respect to the rotor 142, and which is mounted on the same support 121 which carries the electromagnets 120a, 120b. The energization/de-energization of the third electromagnet 140 preferably causes the attraction/release of the armature 143 towards/away from the rotor 142 which rotationally operates the journal 1c. The second coupling is also preferably reversible, it being possible to apply the movement to the pulley 141 so that the journal 1c is driven, or the movement may be applied to the journal 1c so that the pulley 141 is driven.

In the embodiment shown in FIG. 2, the journal 1c is integral with the shaft 1b and the second coupling 140 therefore forms a system for rotational operation of the fan 1 at a third auxiliary speed. Although not shown, it is envisaged, however, that the journal 1c may rotate independently of the shaft 1b, forming an auxiliary service drive system independent of the fan and able for example to operate the spindle of the pump (not shown) for recirculation of the engine coolant.

According to certain embodiments it is also envisaged that the third coupling can cause rotation of the journal 1c in a direction of movement opposite to that caused by the two main pulleys 124c,136, thus being effective for cleaning the radiator from which the particles accumulated by the rotation of the fan determined by the direction of rotation of the first pulley 124 and the second pulley 134 are sucked.

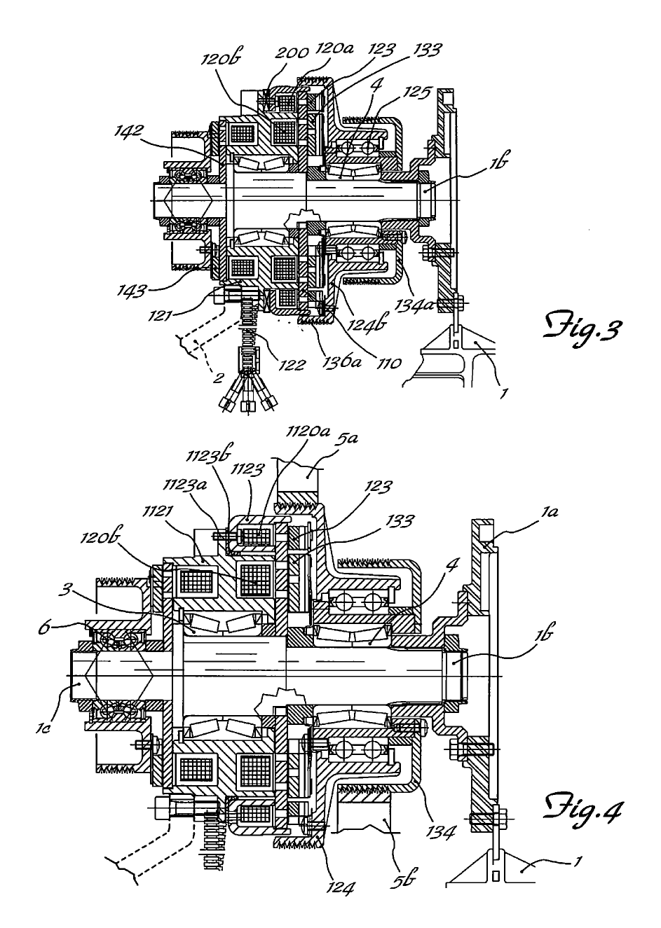

In a further embodiment (FIG. 3) is it is envisaged that either one or both of the electromagnets 120a,120b is/are associated with a permanent magnet 200 able to keep the respective armature 123,133 attracted against the associated rotor 110,142 and to be neutralized by excitation of the electromagnet 120a,120b, providing a failsafe operating mode which ensures the rotation, and therefore cooling, also in the case of a malfunction of the electric operating and control circuit.

FIG. 4 shows a further embodiment where the first electromagnet 1120a is preferably seated inside an associated C-shaped support 1123 which is attached by screw means 1123a to the support 1121 of the second electromagnet 120b. There being arranged between the support 1123 of the first electromagnet and the support 1121 of the second electromagnet a layer of insulating material 1123b which can improve the efficiency of the magnetic circuits of the two electromagnets 1120a and 1120b, preventing any further relative interference.

It is therefore clear how with the transmission device according to embodiments of the invention that it is possible to obtain the required operation at several speeds and the idle condition with small axial and radial dimensions and a small number of component parts. In addition, since bearing 3 is mounted on the electromagnet support, which is in turn attached to a fixed structure, the effect is obtained that the stresses resulting from the drive belts are transmitted to the fixed structure instead of to the rotating parts, thereby reducing the vibrations, increasing the working life of the assembly and preventing the transmission of said stresses to the shafts of the apparatus associated with the device.

It is also pointed out that, although shown in the form of rollers, the bearings supporting the fixed electromagnets and the cylindrical body 126 may also be designed as ball bearings, suitable dimensions being nevertheless required in order to withstand the belt pulling stresses. Although described in connection with certain constructional forms and certain preferred examples of embodiments of the invention, it is understood that the scope of protection of the present patent is defined solely by the attached claims.

Other embodiments are within the scope and spirit of the invention.

Further, while the description above refers to the invention, the description may include more than one invention.

What is claimed is:

1. A double-acting electromagnetic device for transmitting movement to/from a driven/driving member in a vehicle and comprising:
a shaft that rotates about a longitudinal axis of rotation and that has, mounted relative thereto a first rotor of a first coupling comprising:
a pair of concentric annular electromagnets mounted on a fixed support;
a coaxial bell member;
a coaxial cup member;
a first bearing;
a first armature connected to the coaxial bell member;
a second armature concentric with the first armature and connected to the coaxial cup member which is mounted idle with respect to the shaft via the first bearing and which has a second pulley formed on a side surface;
wherein the support for the electromagnets is attached to a fixed structure part which has a load-bearing function; and
wherein the bell member includes an outer annular edge extending in an axial direction towards the electromagnets and mounted axially over the first rotor.

2. The device according to claim 1, wherein a first pulley with grooves, suitable for engagement with a first drive belt, is formed on an outer radial surface of the outer annular edge of the bell member.

3. The device according to claim 1, wherein the second armature is integral with a first front end of a coaxial cylindrical body, the other end of which carries the coaxial cup member.

4. The device according to claim 1, wherein a coaxial cylindrical body is mounted on an outer ring of the first bearing keyed onto the shaft.

5. The device according to claim 1, wherein the first armature and second armature are respectively connected to the bell member and the cup member by an associated resilient element that is configured to allow axial movements of the armature, but prevent the relative rotation thereof with respect to its support.

6. The device according to claim 1, wherein the first armature and second armature are axially disposed between the first rotor and a bottom of the bell member.

7. The device according to claim 1, wherein the cup member is axially disposed over the cylindrical body.

8. The device according to claim 1, wherein the operation of the shaft is reversible so that said shaft is operable as a driven shaft and a driving shaft.

9. The device according to claim 1, wherein the shaft is axially extended on the side opposite to the first rotor, with respect to the electromagnets of the first coupling, forming a journal on which a second coupling is mounted.

10. The device according to claim 9, wherein the second coupling comprises:
a third pulley, which is mounted on a second bearing keyed onto the journal and to a front surface of which a third armature is connected by an associated resilient element;
a second rotor which is rotationally integral with the journal and axially opposite to the third armature; and
a third electromagnet which is disposed on the side opposite to the third armature, with respect to the second rotor, and which is mounted on the same support that carries the electromagnets.

11. The device according to claim 10, wherein the journal is integral with the shaft.

12. The device according to claim 10, wherein the journal is independent of the shaft.

13. The device according to claim 10, wherein the third pulley of the second coupling rotates in the opposite direction to the direction of rotation of the second pulley and the first pulley of the first coupling.

14. The device according to claim 1, wherein at least one of the electromagnets of the first coupling is associated with a permanent magnet able to keep the respective armature attracted against the first rotor and to be neutralized by excitation of the said electromagnet.

15. The device according to claim 1, wherein the first electromagnet is seated inside an associated support which is attached to the support of the second electromagnet with a layer of insulating material disposed in between.

16. The device according to claim 1, further comprising means for cooling the coolant that comprises at least one of a fan and a fluid recirculation pump.
